(19) United States
(12) Patent Application Publication
(10) Pub. No.: US 2008/0226446 A1
(43) Pub. Date: Sep. 18, 2008

(54) CENTRIFUGAL IMPELLER, FAN APPARATUS, AND ELECTRONIC DEVICE

(75) Inventor: Tadaomi Fujieda, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/048,429

(22) Filed: Mar. 14, 2008

(30) Foreign Application Priority Data
Mar. 16, 2007 (JP) 2007-067779

(51) Int. Cl. F03D 11/00

(52) U.S. Cl. 415/203

(57) ABSTRACT

There is provided a centrifugal impeller that includes a boss portion, a plurality of first centrifugal blades, a plurality of second centrifugal blades, and a coupling portion. The boss portion is capable of rotating. The plurality of first centrifugal blades are provided to the boss portion such that the plurality of first centrifugal blades extend from the boss portion. The plurality of second centrifugal blades are provided around the boss portion such that the plurality of second centrifugal blades are spaced apart from the boss portion. The coupling portion couples the plurality of first centrifugal blades and the plurality of second centrifugal blades.

### CROSS REFERENCES TO RELATED APPLICATIONS

The present invention contains subject matter related to Japanese Patent Application JP 2007-067779 filed in the Japanese Patent Office on Mar. 16, 2007, the entire contents of which being incorporated herein by reference.

### BACKGROUND OF THE INVENTION

1. Field of the Invention

The present invention relates to a centrifugal impeller that generates wind in a centrifugal direction, a fan apparatus that employs the centrifugal impeller, and an electronic device that is mounted with the fan apparatus.

2. Description of the Related Art

As PCs (Personal Computers) are enhanced in performances, heat generators such as ICs (Integrated Circuits) generate heat more, which has been problematic. In view of this, various technologies for releasing heat have been proposed, and products employing such technologies have been manufactured. One method of releasing heat includes intentionally eliminating heated air in a casing of a PC by using a fan, and introducing low-temperature air in the vicinity of the casing to the vicinity of the heat generator, to thereby release heat. Another method includes allowing fins (heat sink) made of metal such as aluminum for releasing heat to be in contact with an IC, transmitting heat generated from the IC to the fins to be released, and intentionally eliminating heated air in the vicinity of the fins for releasing heat by using a fan.

A centrifugal fan is widely employed in such methods of releasing heat. The centrifugal fan generally includes a case, a motor, and a centrifugal impeller. The principle of releasing heat is as follows. The motor rotates the centrifugal impeller. With the centrifugal impeller rotating, air stream in a rotational axis direction introduced via an suction port provided to the case into the inside of the case flows in a radius direction of the centrifugal impeller. The air stream is discharged from the discharge port provided to the case.

As the centrifugal impeller for generating the air stream in the centrifugal fan, one including a cylindrical boss portion (2) and a plurality of centrifugal blades (1a, 1b, . . . , in) is known. The plurality of centrifugal blades (1a, 1b, . . . , in) are directly formed to the cylindrical boss portion (2) in a radial manner (refer to Japanese Patent Application Laid-Open No. 2001-111277; paragraph 0018, FIG. 1). There is also known a centrifugal impeller in which a plurality of rotational vanes (33) are provided to a disk-like bottom plate. Herein, the rotational vanes (33) are spaced apart from a boss portion (refer to Japanese Patent Application Laid-Open No. 2006-336642; paragraph 0012, FIG. 1). Alternatively, there is known a mode in which a plurality of centrifugal blades are provided to an annular auxiliary plate, and a boss portion is fastened to the auxiliary plate with spokes, whereby the centrifugal blades are formed to be spaced apart from the boss portion.

### SUMMARY OF THE INVENTION

However, in the case that the centrifugal blades are directly provided to the boss portion, the air stream in the rotational axis direction is interrupted by the rotating centrifugal blades at inner circumferential sides thereof. As a result, flow path resistance is increased, and thus air blow performances are deteriorated.

Meanwhile, in the case that the centrifugal blades are formed to be spaced apart from the boss portion, the air stream in the vicinity of the boss portion is not accelerated in a centrifugal direction. Also in this case, air blow performances are deteriorated.

In view of the above-mentioned circumstances, there is a need for a technique involving a centrifugal impeller capable of decreasing flow path resistance of air stream in a rotational axis direction and accelerating air stream in the vicinity of a boss portion in a centrifugal direction, a fan apparatus mounted with the centrifugal impeller, and an electronic device mounted with the fan apparatus.

According to an embodiment of the present invention, there is provided a centrifugal impeller that includes a boss portion, a plurality of first centrifugal blades, a plurality of second centrifugal blades, and a coupling portion. The boss portion is capable of rotating. The plurality of first centrifugal blades are provided to the boss portion such that the plurality of first centrifugal blades extend from the boss portion. The plurality of second centrifugal blades are provided around the boss portion such that the plurality of second centrifugal blades are spaced apart from the boss portion. The coupling portion couples the plurality of first centrifugal blades and the plurality of second centrifugal blades.

According to this embodiment, the plurality of second centrifugal blades are spaced apart from the boss portion, so there is a space between the boss portion and the second centrifugal blades. Accordingly, air stream in a rotational axis direction generated owing to the rotation of the centrifugal impeller is likely to be sucked. That is, flow path resistance of the air stream in the rotational axis direction is decreased. In addition, noise due to the flow path resistance of the air stream can be suppressed.

In addition, the air stream in the rotational axis direction sucked by the centrifugal impeller is accelerated in the vicinity of the boss portion by the plurality of rotating first centrifugal blades in the centrifugal direction. Accordingly, the air stream in the vicinity of the boss portion of the centrifugal impeller can be accelerated in the centrifugal direction. Thus, flow rate of the air stream discharged from the centrifugal impeller in the centrifugal direction can be increased.

In the centrifugal impeller of this embodiment, the coupling portion may couple edge portions of the plurality of first centrifugal blades in a rotational axis direction and edge portions of the plurality of second centrifugal blades in the rotational axis direction.

With this structure, the centrifugal blades can be stably coupled to each other.

In the centrifugal impeller of this embodiment, the coupling portion may couple center portions of the plurality of first centrifugal blades in a rotational axis direction and center portions of the plurality of second centrifugal blades in the rotational axis direction.

With this structure, the centrifugal blades are stably coupled to each other. In addition, the air stream in both directions of the rotational axis direction is smoothly converted to the air stream in the centrifugal direction. Accordingly, noise due to the abrupt change of directions of the air stream can be suppressed.

In the centrifugal impeller of this embodiment, each of the plurality of first centrifugal blades may include a first blade area that is provided to an outer circumferential side of each of the plurality of first centrifugal blades and has a first width in a rotational axis direction, and a second blade area that is provided to an inner circumferential side of each of the plurality of first centrifugal blades and has a second width larger than the first width in the rotational axis direction.

With this structure, the air in the vicinity of the boss portion of the centrifugal impeller is furthermore accelerated in the centrifugal direction.

According to another embodiment of the present invention, there is provided a fan apparatus including a centrifugal impeller, a drive portion, and an accommodation portion. The centrifugal impeller includes a boss portion, a plurality of first centrifugal blades, a plurality of second centrifugal blades, and a coupling portion. The boss portion is capable of rotating. The plurality of first centrifugal blades are provided to the boss portion such that the plurality of first centrifugal blades extend from the boss portion. The plurality of second centrifugal blades are provided around the boss portion such that the plurality of second centrifugal blades are spaced apart from the boss portion. The coupling portion couples the plurality of first centrifugal blades and the plurality of second centrifugal blades. The drive portion rotationally drives the centrifugal impeller. The accommodation portion includes an suction port that sucks gas in a rotational axis direction of the centrifugal impeller and an discharge port that discharges the gas sucked from the suction port. The accommodation portion accommodates the centrifugal impeller.

With this structure, in the centrifugal impeller, flow path resistance of air stream sucked via the suction port provided to the accommodation portion can be suppressed. In addition, air stream in the vicinity of the boss portion of the centrifugal impeller can be accelerated in the centrifugal direction. Accordingly, flow rate of the air stream discharged via the discharge port provided to the accommodation portion can be increased. In addition, noise due to flow resistance at the time of sucking the air stream is suppressed.

According to another embodiment of the present invention, there is provided an electronic device including a heat generator and a fan apparatus. The fan apparatus is capable of cooling the heat generator. The fan apparatus includes a centrifugal impeller, a drive portion, and an accommodation portion. The centrifugal impeller includes a boss portion, a plurality of first centrifugal blades, a plurality of second centrifugal blades, and a coupling portion. The plurality of first centrifugal blades are provided to the boss portion such that the plurality of first centrifugal blades extend from the boss portion. The plurality of second centrifugal blades are provided around the boss portion such that the plurality of second centrifugal blades are spaced apart from the boss portion. The coupling portion couples the plurality of first centrifugal blades and the plurality of second centrifugal blades. The drive portion rotationally drives the centrifugal impeller.

The accommodation portion includes an suction port that sucks gas in a rotational axis direction of the centrifugal impeller and an discharge port that discharges the gas sucked from the suction port. The accommodation portion accommodates the centrifugal impeller.

With this structure, the flow rate of the air stream discharged via the discharge port provided to the accommodation portion of the fan apparatus can be increased. Thus, heat generated by the heat generator can be released efficiently. In addition, noise due to flow path resistance at the time of sucking the air stream can be suppressed. Thus, a user may less feel uncomfortable.

As the heat generator, an electronic component such as an IC is exemplarily employed, but not limited thereto. Any member that generates heat such as a heat sink or an electronic member other than an IC may be employed.

According to the embodiments of the present invention as described above, flow path resistance of the air stream in the rotational axis direction can be decreased. Further, the air stream in the vicinity of the boss portion can be accelerated in the centrifugal direction.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is an exploded perspective view showing a fan apparatus according to a first embodiment of the present invention;

FIG. 2 is a cross-sectional view showing an inner structure of the fan apparatus shown in FIG. 1;

FIG. 3 is an exploded perspective view showing a fan apparatus according to a second embodiment of the present invention;

FIG. 4 is a perspective view showing a centrifugal impeller according to the second embodiment of the present invention;

FIG. 5 is a front view showing the centrifugal impeller according to the second embodiment of the present invention;

FIG. 6 is a rear view showing the centrifugal impeller according to the second embodiment of the present invention;

FIG. 7 is a top view showing the centrifugal impeller according to the second embodiment of the present invention;

FIG. 8 is a bottom view showing the centrifugal impeller according to the second embodiment of the present invention;

FIG. 9 is a right-side view showing the centrifugal impeller according to the second embodiment of the present invention;

FIG. 10 is a left-side view showing the centrifugal impeller according to the second embodiment of the present invention;

FIG. 11 is a cross-sectional view showing a fan apparatus according to a third embodiment of the present invention;

FIG. 12 is a perspective view showing a cooling apparatus according to a fourth embodiment of the present invention;

FIG. 13 is a perspective view of a computer according to a fifth embodiment of the present invention;

FIG. 14 is a view showing a centrifugal impeller mounted to a cooling apparatus when examining a cooling performance of a conventional cooling apparatus; and

FIG. 15 is a diagram showing the result of the experiment in comparing the cooling performance of the conventional cooling apparatus and a cooling performance of the cooling apparatus according to one of the embodiments of the present invention.

### DESCRIPTION OF PREFERRED EMBODIMENTS

In the following, embodiments of the present invention will be described with reference to the accompanying drawings.

### First Embodiment

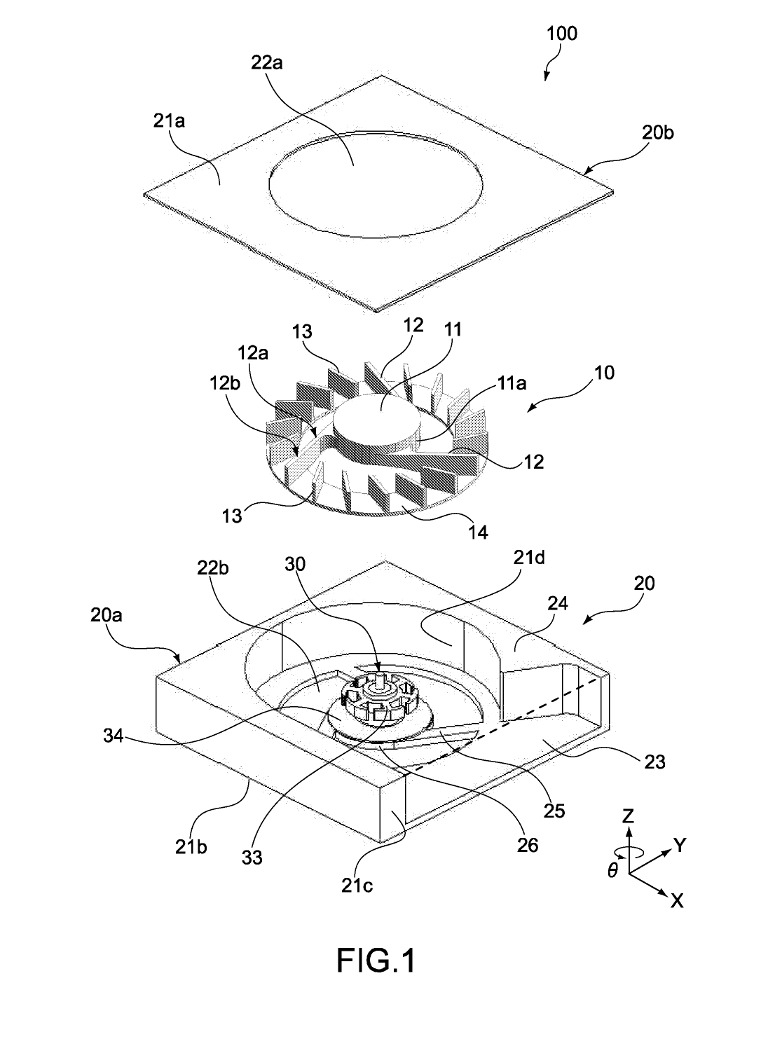

A first embodiment of the present invention will be described. FIG. 1 is an exploded perspective view showing a fan apparatus according to this embodiment.

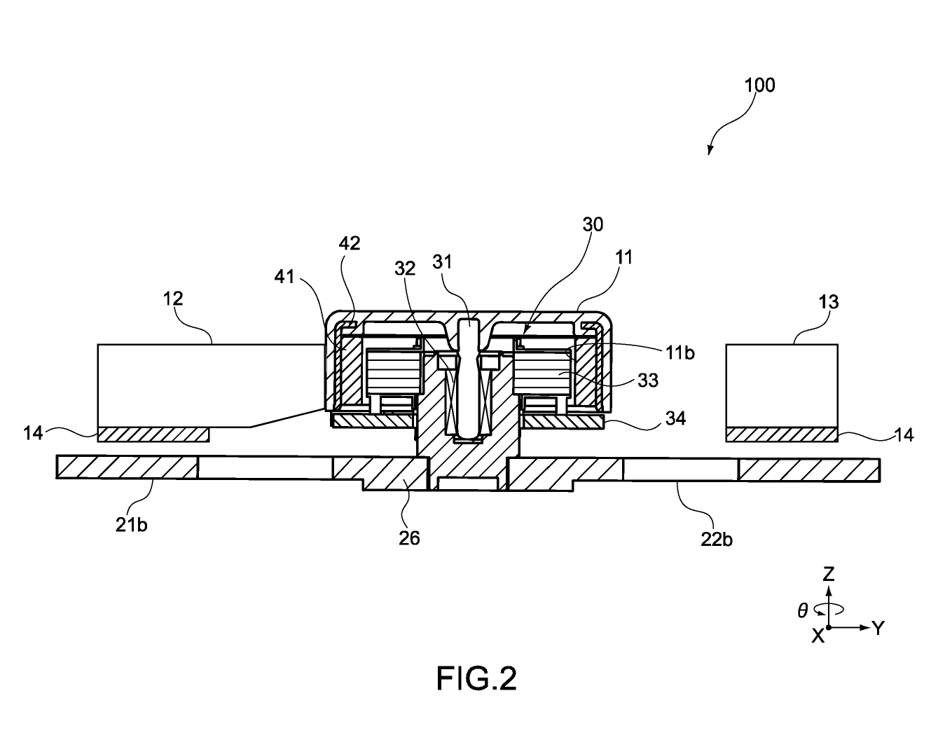

FIG. 2 is a cross-sectional view showing an inner structure of the fan apparatus of FIG. 1, denoted by reference numeral 100.

As shown in FIG. 1, the fan apparatus 100 includes a centrifugal impeller (propeller for a centrifugal fan) 10, a case 20, and a stator 30.

The centrifugal impeller 10 includes, at a center thereof, a substantially-cylindrical boss portion 11 capable of rotating in a θ direction about an axis in a Z direction. The boss portion 11 is provided with, at an outer circumferential surface 11a, a plurality of centrifugal long blades (first centrifugal blades) 12.

The plurality of centrifugal long blades 12 extend from the outer circumferential surface 11a in a centrifugal direction by predetermined angles. The plurality of centrifugal long blades 12 are arranged to have substantially the same distances in the rotational direction (θ direction). Further, a plurality of short blades (second centrifugal blades) 13 are provided around the boss portion 11 so as to be spaced apart from the outer circumferential surface 11a of the boss portion 11. The plurality of centrifugal short blades 13 are arranged to have substantially the same distances in the rotational direction (θ direction). Edge portions of the centrifugal long blades 12 at outer circumferential sides 12b in the rotational axis direction (Z direction) and edge portions of the centrifugal short blades 13 in the rotational axis direction (Z direction) are coupled by a substantially-annular coupling plate 14 being a coupling portion. In other words, lower portions of the centrifugal long blades 12 and lower portions of the centrifugal short blades 13 are coupled by the coupling plate 14.

The centrifugal impeller 10 is typically made of, but not limited to, a resin. The centrifugal impeller 10 may alternatively be made of metal or other materials.

The number of the centrifugal long blades 12 and the number of the centrifugal short blades 13 are not limited. Of those, the number of the centrifugal long blades 12 is three in this embodiment, but may be two, four, or the like.

It should be noted that in the description, the term “centrifugal direction” refers to any direction (X direction, Y direction) orthogonal to the rotational axis, and thus refers to any direction extending substantially in a radial direction from a given point on the rotational axis being an origin.

The case 20 substantially has a shape of rectangular parallelepiped, and includes an upper surface 21a, a lower surface 21b, and side surfaces 21c. The case 20 typically includes, for example, a main body 20a and a cover member 20b attached to an upper portion of the main body 20a. The upper surface 21a is provided with, substantially at a center thereof, a substantially-circular upper suction port 22a. The lower surface 21b is provided with, substantially at a center thereof, a substantially-circular lower suction port 22b. One of the side surfaces 21c is provided with an discharge port 23. The case 20 includes therein a space formed with an inner wall surface 21d in which the centrifugal impeller 10 is accommodated. The inner wall surface 21d is formed with, at a given portion thereof, a tongue portion 24.

At a center portion of the lower discharge port 22b, a hold plate 26 is disposed. The hold plate 26 is integrally provided with ribs 25 extending from an outer circumferential edge of the lower suction port 22b. A circuit board 34 for driving a motor including the stator 30 is mounted to the hold plate 26.

As shown in FIG. 2, the stator 30 includes a shaft 31, a bearing 32, and a core 33. The shaft 31 is fixed to the boss portion 11 of the centrifugal impeller 10. A coil is wound around the core 33. The boss portion 11 is hollow. A magnet 41 and a rotor yoke 42 are mounted to an inner circumferential surface 11b of the boss portion 11. The stator 30, the magnet 41, and the rotor yoke 42 constitute a motor (drive portion).

Subsequently, operation of the fan apparatus 100 structured as described above will be described.

Upon driving of the motor, the centrifugal impeller 10 rotates at predetermined rpm. Air outside the case 20 in sucked into the case 20 via the upper suction port 22a and the lower suction port 22b. As a result, air stream in the rotational axis direction (Z direction) is generated.

The air stream is took in a space between the boss portion 11 and the plurality of centrifugal short blades 13. Since, in this embodiment, the predetermined space is provided between the boss portion 11 and the plurality of centrifugal short blades 13, the air stream is readily sucked. As a result, flow path resistance of the air stream from the upper suction port 22a and the lower suction port 22b in the rotational axis direction (Z direction) can be decreased, and therefore turbulence and noise can be suppressed.

The air stream took in the space between the boss portion 11 and the plurality of centrifugal short blades 13 is accelerated in the centrifugal direction by the rotating centrifugal long blades 12 at inner sides 12a. Accordingly, the air stream is accelerated in the centrifugal direction in the vicinity of the boss portion 11.

The air stream accelerated in the centrifugal direction is further accelerated in the centrifugal direction by the rotating centrifugal long blades 12 at the outer circumferential sides 12b and the plurality of rotating centrifugal short blades 13. The air stream thus accelerated in the centrifugal direction is flowed along the inner wall surface 21d and discharged via the discharge port 23.

The flow rate of the air stream sucked via the suction ports 22a and 22b (hereinafter sometimes integrally denoted by reference numeral 22) provided to the case 20 and the flow rate of the air stream discharged via the discharge port 23 provided thereto are thus increased. Air-blow performances are thus improved.

### Second Embodiment

Subsequently, a second embodiment of the present invention will be described. Hereinafter, the description of members, functions, and the like similar to those of the fan apparatus 100 according to the first embodiment will be simplified and omitted. Members, functions, and the like different from those of the fan apparatus 100 will mainly be described.

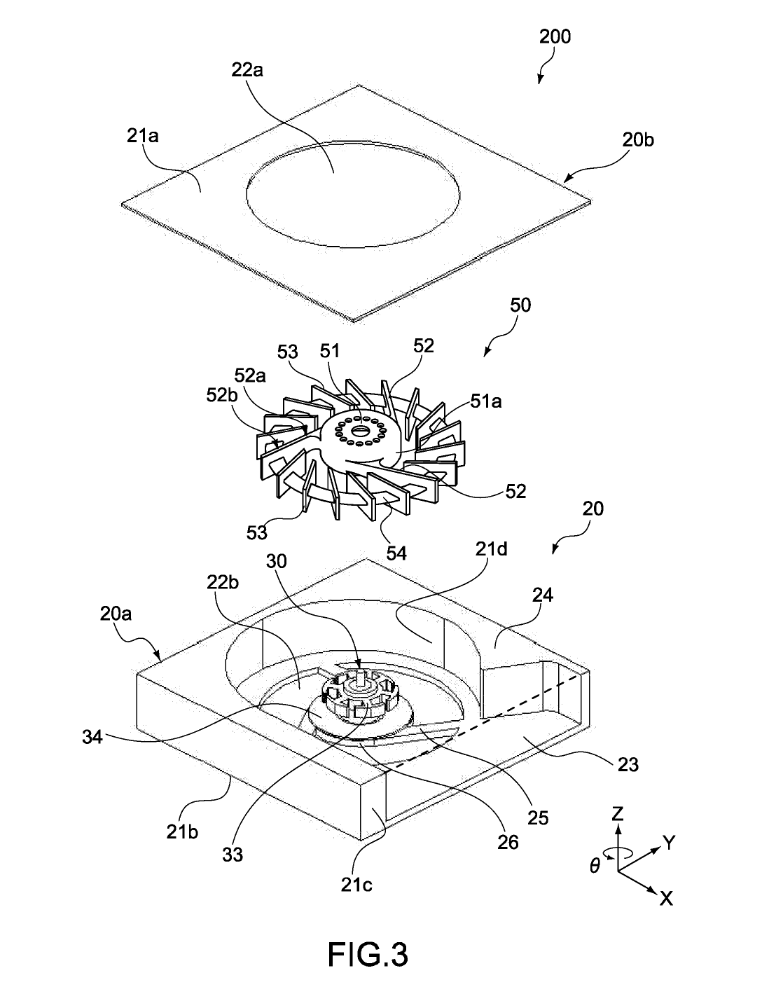

FIG. 3 is an exploded perspective view of a fan apparatus according to this embodiment.

The fan apparatus, denoted by reference numeral 200, includes a centrifugal impeller 50, the case 20, and the stator 30.

Among those, the centrifugal impeller 50 is different from the centrifugal impeller 10 described above. So the centrifugal impeller 50 will mainly be described in this embodiment.

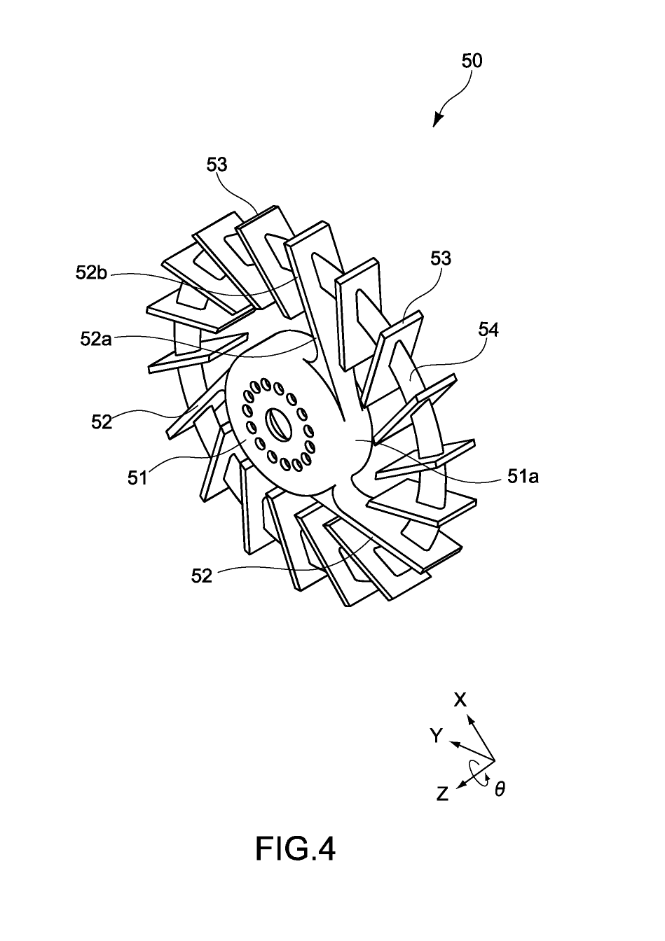

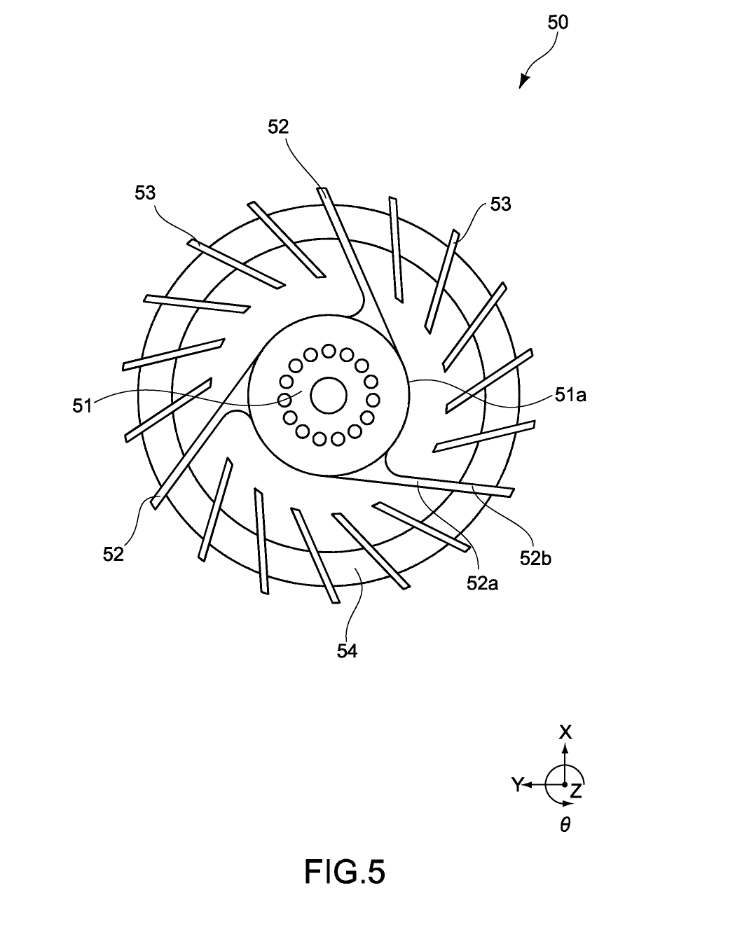

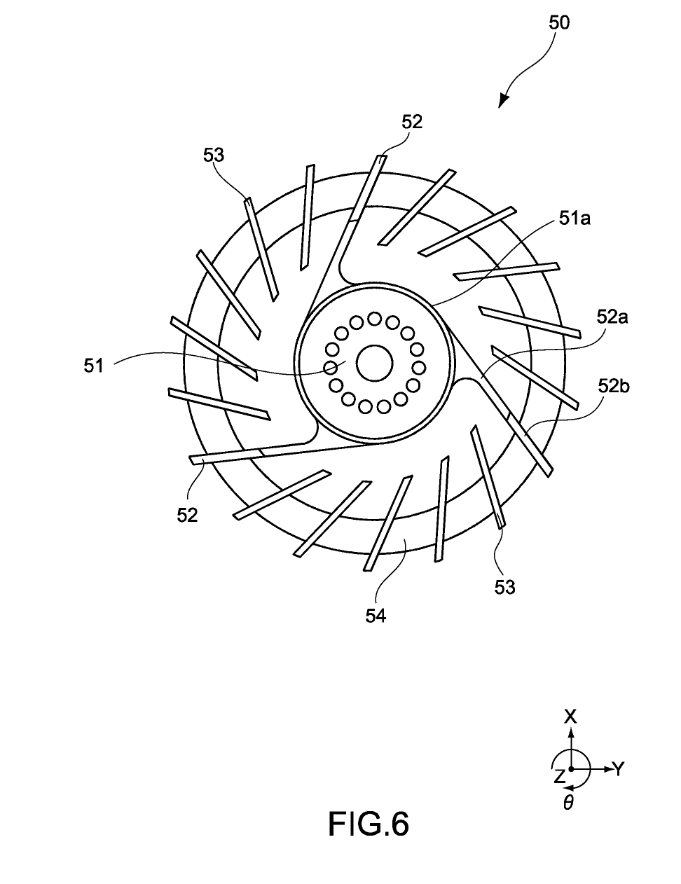

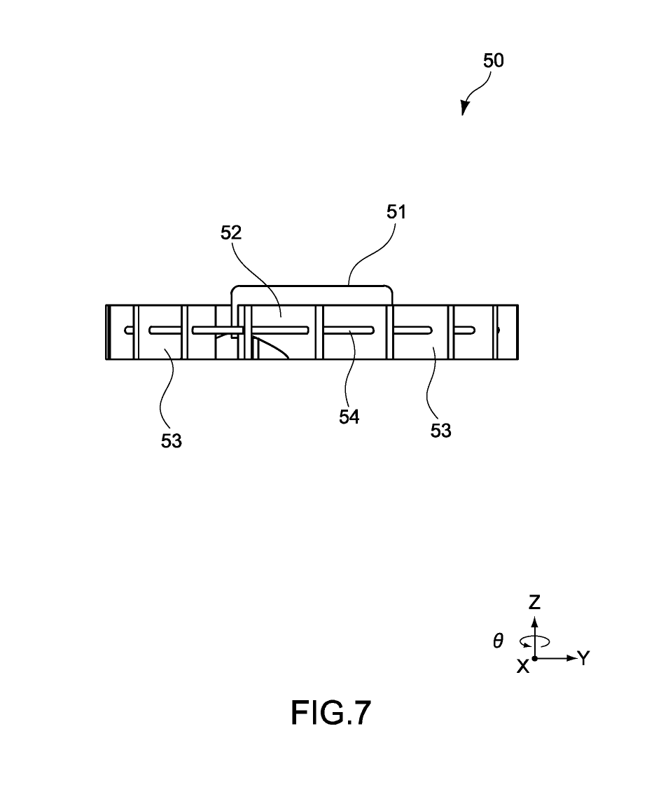

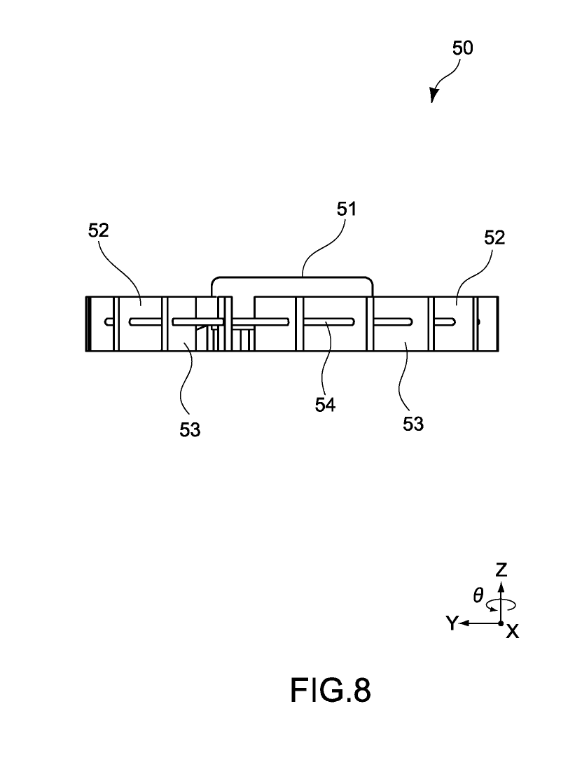

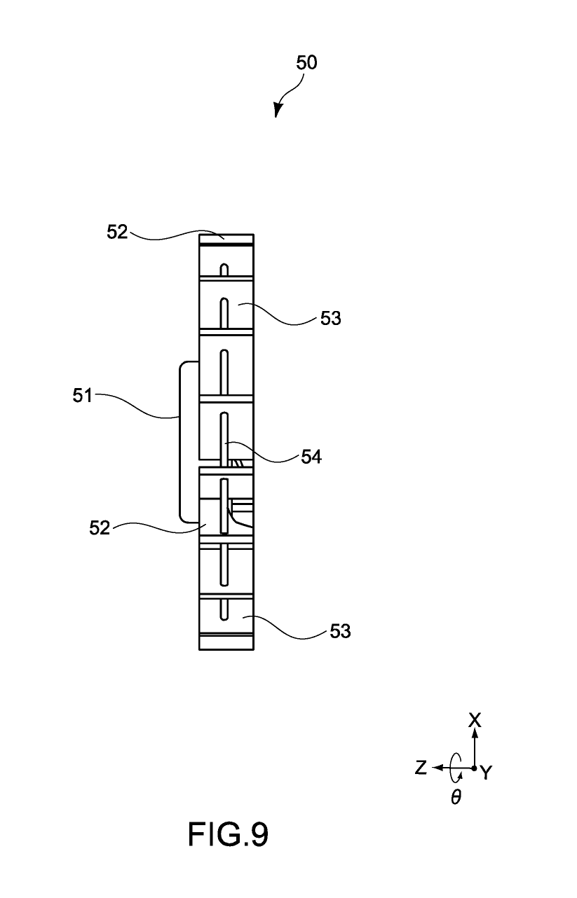

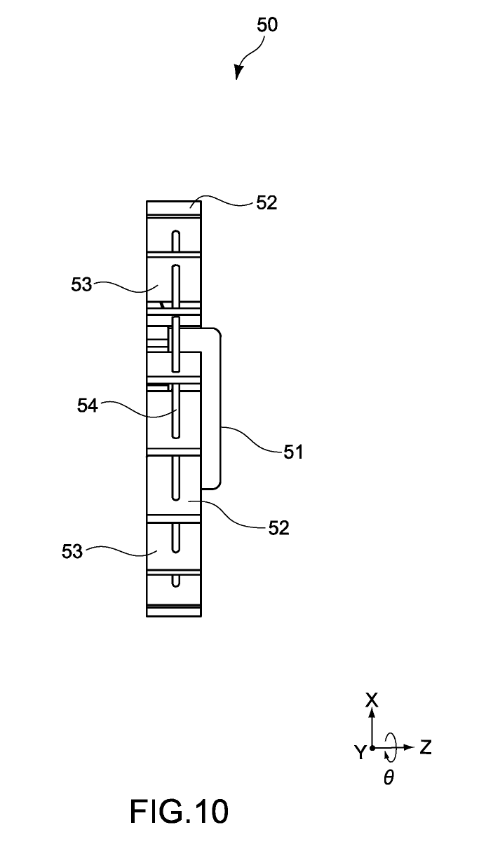

FIG. 4 is a perspective view showing the centrifugal impeller 50. FIG. 5 is a front view thereof. FIG. 6 is a rear view thereof. FIG. 7 is a top view thereof. FIG. 8 is a bottom view thereof. FIG. 9 is a right-side view thereof. FIG. 10 is a left-side view thereof.

The centrifugal impeller 50 includes a boss portion 51 and a plurality of centrifugal long blades 52. The boss portion is provided at a center of the centrifugal impeller 50. The plurality of centrifugal long blades 52 extend from an outer circumferential surface 51a of the boss portion 51 in a centrifugal direction by predetermined angles. The centrifugal impeller 50 further includes a plurality of centrifugal short blades 53 provided so as to be spaced apart from the boss portion 51. An annular coupling plate 54 couples center portions of the plurality of centrifugal long blades 52 at outer circumferential sides 52b in the rotational axis direction (Z direction) and center portions of the plurality of centrifugal short blades 53 in the rotational axis direction.

Subsequently, operation of the fan apparatus 200 structured as described above will be described.

The centrifugal impeller 50 rotates at predetermined rpm, and then air stream in the rotational axis direction (Z direction) is generated. The air stream is sucked into the case 20 via the upper suction port 22a and the lower suction port 22b, and took in a space between the boss portion 51 and the plurality of centrifugal short blades 53. The air stream in the rotational axis direction (Z direction) is accelerated in the centrifugal direction by the plurality of rotating centrifugal long blades 52 at inner circumferential sides 52a. The air stream accelerated in the centrifugal direction is further accelerated in the centrifugal direction by the plurality of rotating long blades 52 at the outer circumferential sides 52b and the plurality of rotating centrifugal short blades 53. Then the air stream thus accelerated in the centrifugal direction is flowed along the inner wall surface 21d and discharged via the discharge port 23.

Since, as described above, the coupling plate 54 couples the center portions of the plurality of centrifugal long blades 52 and the center portions of the plurality of centrifugal short blades 53, the air stream sucked via the upper suction port 22a is smoothly flown in the centrifugal direction while being flown above the coupling plate 54. Meanwhile, the air stream sucked via the lower suction port 22b is smoothly flown in the centrifugal direction while being flown below the coupling plate 54. Accordingly, noise generated by abrupt change of directions of the air stream can be suppressed.

### Third Embodiment

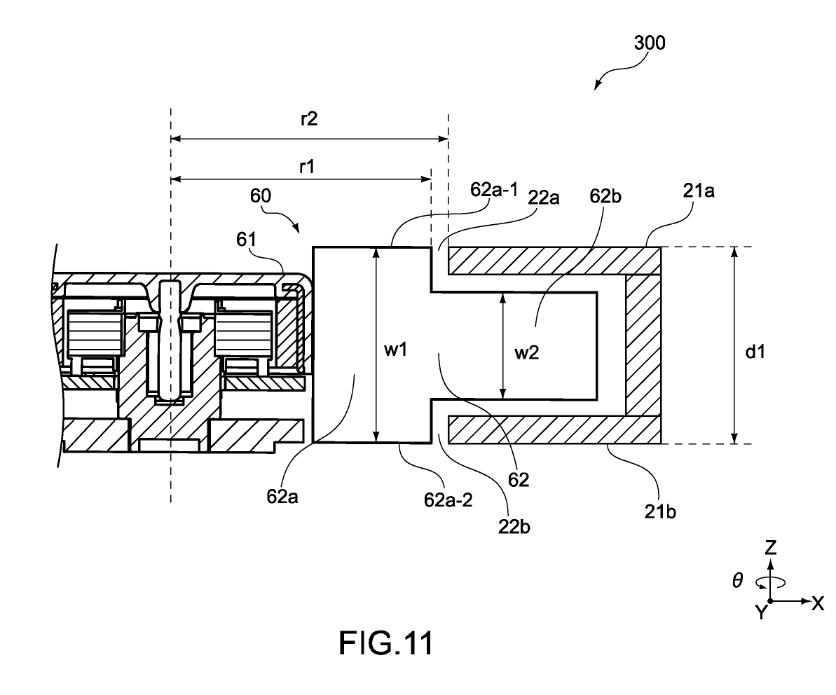

Subsequently, a third embodiment of the present invention will be described. FIG. 11 is a cross-sectional view of a fan apparatus according to the third embodiment.

In this embodiment, a centrifugal long blade 62 includes, at an inner circumferential side thereof, a second blade area 62a, and, at an outer circumferential side thereof, a first blade area 62b. The centrifugal long blade 62 is structured such that the second blade area 62a has a width w1 in the rotational axis direction larger than a width w2 of the first blade area 62b in the rotational axis direction. For example, the width w1 of the centrifugal long blade 62 at the inner circumferential side is substantially the same as a distance d1 between the upper surface 21a and the lower surface 21b of the case 20. In other words, an upper edge portion 62a-1 of the second blade area 62a of the centrifugal long blade 62 and the upper surface 21a of the case 20 are substantially in a same plane. Further, a lower edge portion 62a-2 of the second blade area 62a and the lower surface 21b of the case 20 are substantially in a same plane. A length r1 from the center of the boss portion 61 to an outer circumferential end of the second blade area 62a is shorter than a radius r2 of each suction port 22 (upper suction port 22a, lower suction port 22b). That is, the second blade area 62a is structured such that the upper edge portion 62a-1 of the second blade area 62a is arranged in the upper suction port 22a, and the lower edge portion 62a-2 thereof is arranged in the lower suction port 22b.

The fan apparatus, denoted by reference numeral 300, structured as described above provides the following advantageous effects.

Since the width w1 of the second blade area 62a of the centrifugal long blade 62 is made larger than the width w2 of the first blade area 62b thereof, the air stream in the rotational axis direction is furthermore accelerated in the centrifugal direction in the vicinity of a boss portion 61 of a centrifugal impeller 60. In addition, the width w1 is substantially the same as the distance dl being a height of the case 20, so the height (thickness) of the fan apparatus 300 is not increased. Thus, according to this embodiment, the case 20 is downsized or thinned while the flow rate being increased.

It should be noted that the centrifugal impeller 60 of this embodiment includes, in the similar manner as the centrifugal impeller according to each of the above-mentioned embodiments, a plurality of centrifugal short blades (not shown), a plurality of centrifugal long blades 62, and a coupling plate (not shown) for coupling those centrifugal blades.

In this embodiment, the width w1 is not necessary the same as the distance d1.

In this embodiment, the second blade area 62a of the centrifugal long blade 62 is symmetrically formed in the rotational axis direction. The second blade area 62a may alternatively be asymmetrically formed.

### Fourth Embodiment

Subsequently, a fourth embodiment of the present invention will be described.

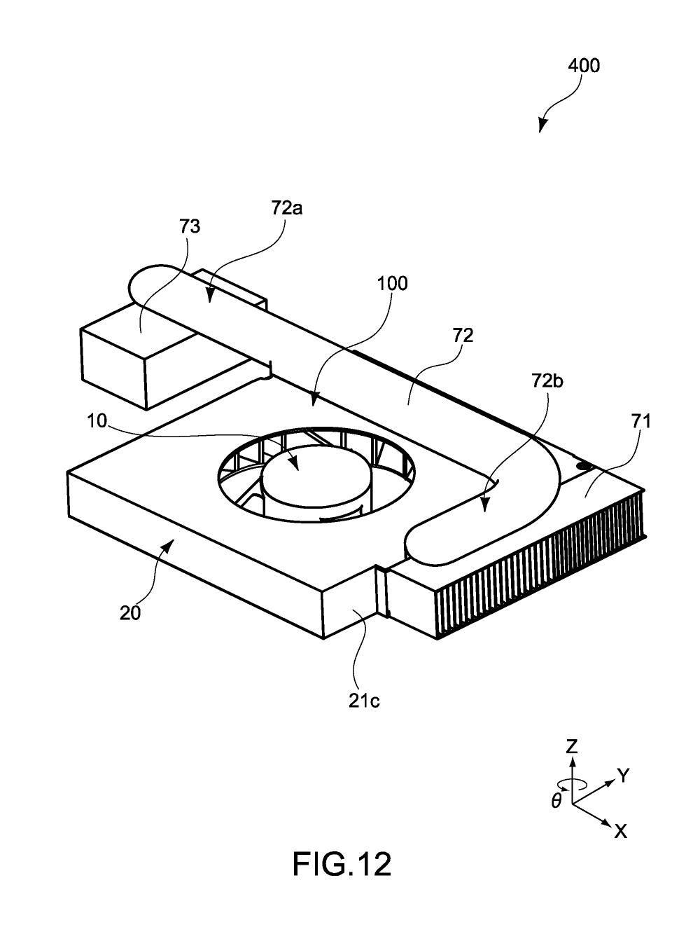

FIG. 12 is a perspective view showing a cooling apparatus of this embodiment.

The cooling apparatus of this embodiment, denoted by reference numeral 400, includes the fan apparatus 100 according to the first embodiment of the present invention, and a heat sink 71 and a heat pipe 72 mounted to the fan apparatus 100.

The heat sink 71 is made of, for example, metal such as copper or aluminum. The heat sink 71 is attached to one of the side surfaces 21c of the case 20, to which the discharge port 23 is provided. In the heat pipe 72, a heat absorbing portion 72a is allowed to be in contact with a heat generator 73 such as an IC, and a heat releasing portion 72b is allowed to be in contact with the heat sink 71.

The heat generator 73 heats the heat absorbing portion 72a of the heat pipe 72. A refrigerant inside the heat pipe 72 absorbs the heat, vaporizes, moves into the heat releasing portion 72b, and generates heat. The heat is transmitted to the heat sink 71. The refrigerant that has released the heat liquefies, and flows back to the heat absorbing portion 72a owing to, for example, capillarity of the heat pipe 72.

The heat transmitted to the heat sink 71 by the heat releasing portion 72b is released to the outside owing to the air stream discharged via the discharge port 23 by the rotating centrifugal impeller 10.

Accordingly, even in the case of, for example, an electronic device which does not have a large space therein, heat is caused to move appropriately and is released to the outside.

It should be noted that the fan apparatus 100 is exemplarily employed as a fan apparatus of the cooling apparatus. Alternatively, the fan apparatus 200 or the fan apparatus 300 may be employed.

### Fifth Embodiment

Subsequently, a fifth embodiment of the present invention will be described.

In this embodiment, the cooling apparatus 400 according to the fourth embodiment of the present invention is mounted to an electronic device, specifically, a lap-top computer.

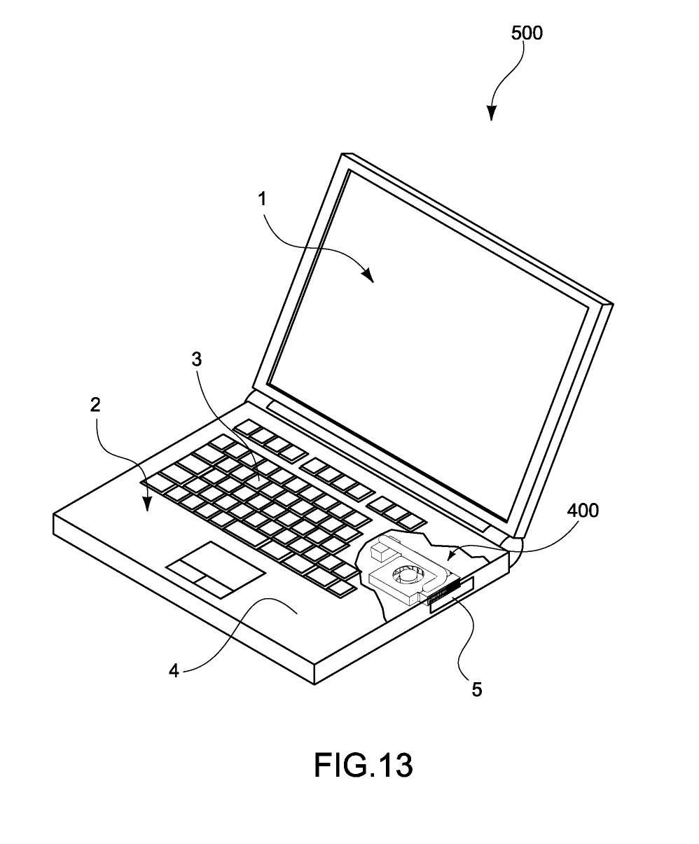

FIG. 13 is a perspective view of the computer according to this embodiment.

As shown in FIG. 13, the computer, denoted by reference numeral 500, includes, for example, a liquid crystal monitor portion 1 and a main body portion 2. The main body portion 2 is provided with a keyboard unit 3 and the like. The main body portion 2 includes an outer casing 4. The outer casing 4 is formed with, at a side surface thereof, an opening 5. The cooling apparatus 400 is arranged, for example, below the keyboard unit 3 such that the opening 5 opposes the heat sink 71 of the cooling apparatus 400. Accordingly, heat inside the outer casing 4 and heat generated by a heat generator such as an IC accommodated in the outer casing 4 can be released to the outside.

The fan apparatus included in the cooling apparatus 400 mounted to the computer 500 can increase, as described above, the flow rate of the air stream sucked via the suction ports 22 and discharged via the discharge port 23. Thus, the heat inside the outer casing 4 or the heat generated by the heat generator inside the outer casing 4 can be efficiently discharged to the outside. Accordingly, the inside of the outer casing 4 can be efficiently cooled. In addition, the fan apparatus 100 can suppress the noise due to the flow path resistance at the time of sucking the air stream as described above. Thus, a user may less feel uncomfortable.

It should be noted that, the electronic device is not limited to the lap-top computer currently exemplified, but may be a computer such as a desk-top computer or a server computer, a PDA (Personal Digital Assistance), an electronic dictionary, a camera, a display apparatus, an AV device, a projector, a mobile phone, a game device, a car navigation device, a robot device, or other electronic products.

The inventor of the present invention performed an experiment to compare cooling performance of a conventional cooling apparatus and cooling performance of the cooling apparatus according to one of the embodiments of the present invention. In the experiment, the cooling apparatus 400 mounted with a conventional centrifugal impeller instead of the centrifugal impeller 10 was compared to the cooling apparatus 400 mounted with the centrifugal impeller according to one of the embodiments of the present invention.

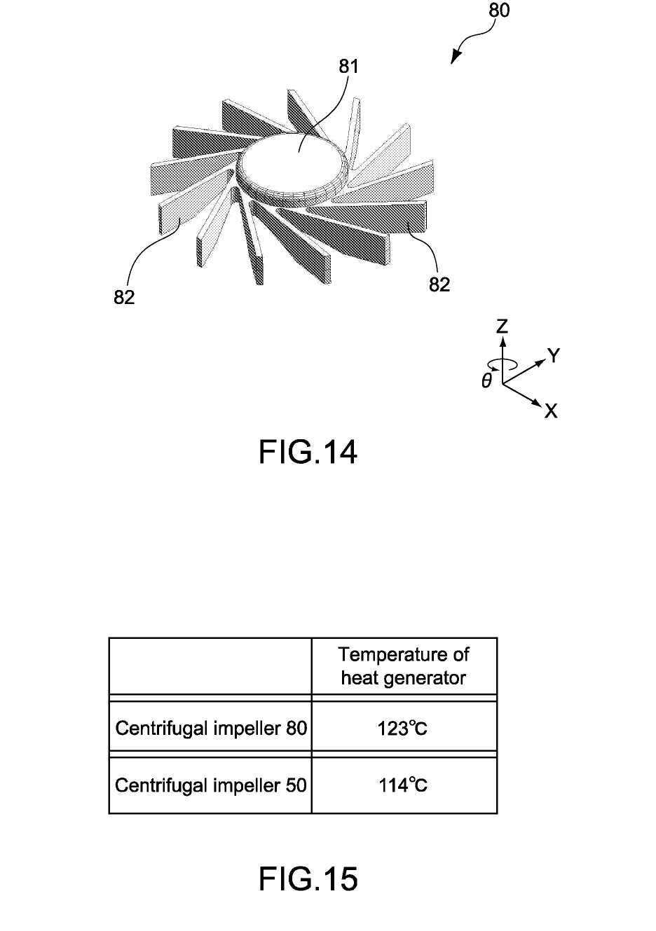

FIG. 14 is a view showing the centrifugal impeller mounted to the cooling apparatus 400 when examining the cooling performance of the conventional cooling apparatus. The centrifugal impeller, denoted by reference numeral 80, includes a cylindrical boss portion 81 and a plurality of centrifugal blades 82. The plurality of centrifugal blades 82 radially extend directly from the boss portion 81 in a centrifugal direction by predetermined angles.

Meanwhile, when examining the cooling performance of the cooling apparatus according to one of the embodiments of the present invention, the centrifugal impeller 50 shown in FIG. 4 to FIG. 10 was mounted to the cooling apparatus 400.

In this experiment, the temperature of each heat generator 73 was measured to evaluate the cooling performance.

FIG. 15 shows the result of the experiment. As shown in FIG. 15, the temperature of the heat generator in the cooling apparatus mounted with the centrifugal impeller 50 was lower by approximately 10° C. than the temperature of the heat generator in the cooling apparatus mounted with the centrifugal impeller 80.

It should be understood by those skilled in the art that various modifications, combinations, sub-combinations and alternations may occur depending on design requirements and other factors insofar as they are within the scope of the appended claims or the equivalents thereof.

What is claimed is:

1. A centrifugal impeller, comprising:
a boss portion that is capable of rotating;
a plurality of first centrifugal blades provided to the boss portion such that the plurality of first centrifugal blades extend from the boss portion;
a plurality of second centrifugal blades provided around the boss portion such that the plurality of second centrifugal blades are spaced apart from the boss portion; and
a coupling portion that couples the plurality of first centrifugal blades and the plurality of second centrifugal blades.

2. The centrifugal impeller as set forth in claim 1, wherein the coupling portion couples edge portions of the plurality of first centrifugal blades in a rotational axis direction and edge portions of the plurality of second centrifugal blades in the rotational axis direction.

3. The centrifugal impeller as set forth in claim 1, wherein the coupling portion couples center portions of the plurality of first centrifugal blades in a rotational axis direction and center portions of the plurality of second centrifugal blades in the rotational axis direction.

4. The centrifugal impeller as set forth in claim 1, wherein each of the plurality of first centrifugal blades includes a first blade area that is provided to an outer circumferential side of each of the plurality of first centrifugal blades and has a first width in a rotational axis direction, and a second blade area that is provided to an inner circumferential side of each of the plurality of first centrifugal blades and has a second width larger than the first width in the rotational axis direction.

5. A fan apparatus, comprising:
a centrifugal impeller including a boss portion that is capable of rotating, a plurality of first centrifugal blades provided to the boss portion such that the plurality of first centrifugal blades extend from the boss portion, a plurality of second centrifugal blades provided around the boss portion such that the plurality of second centrifugal blades are spaced apart from the boss portion, and a coupling portion that couples the plurality of first centrifugal blades and the plurality of second centrifugal blades;
a drive portion that rotationally drives the centrifugal impeller; and
an accommodation portion including an suction port that sucks gas in a rotational axis direction of the centrifugal impeller and an discharge port that discharges the gas sucked from the suction port, that accommodates the centrifugal impeller.

6. An electronic device, comprising
a heat generator; and
a fan apparatus that is capable of cooling the heat generator, and includes a centrifugal impeller including a boss portion that is capable of rotating, a plurality of first centrifugal blades provided to the boss portion such that the plurality of first centrifugal blades extend from the boss portion, a plurality of second centrifugal blades provided around the boss portion such that the plurality of second centrifugal blades are spaced apart from the boss portion, and a coupling portion that couples the plurality of first centrifugal blades and the plurality of second centrifugal blades, a drive portion that rotationally drives the centrifugal impeller, and an accommodation portion including an suction port that sucks gas in a rotational axis direction of the centrifugal impeller and an discharge port that discharges the gas sucked from the suction port, that accommodates the centrifugal impeller.
